(19) United States
(12) Patent Application Publication
(10) Pub. No.: US 2006/0190534 A1
(43) Pub. Date: Aug. 24, 2006

(54) Method and system for browsing a plurality of information items

(75) Inventor: Yuzuru Nagano, Tokyo (JP)

Correspondence Address: Paul J. Esatto, Jr.;Scully, Scott, Murphy & Presser, 400 Garden City Plaza, Garden City, NY, 11530, US

(73) Assignee: NEC Corporation, Tokyo (JP)

(21) Appl. No.: 11/359,278

(22) Filed: Feb. 22, 2006

(30) Foreign Application Priority Data
Feb. 23, 2005 (JP) 047969/2005

(51) Int. Cl. G06F 15/16

(52) U.S. Cl. 709/203

(57) ABSTRACT

In an information browsing method and system, for article information of an article described in an Web site, tag information assigning a tag to each particular article or each topic in the article information is linked with a content of the article to create a data item to store the data item in a database. One Web site is installed to be linked with the database to enable a plurality of sites to browse the article information. By accessing the Web server linked with the database, a service user can browse, at a time, information originally provided at plural sites. This saves the time to access the plural sites and suppresses reception of unnecessary data to thereby prevent traffic of data not required.

### BACKGROUND OF THE INVENTION

1. Field of the Invention

The present invention relates to a method of and a system for browsing a plurality of information items by storing tag information in a World Wide Web (Web) page.

2. Description of the Prior Art

To browse an Web site in the prior art, when a Uniform Resource Locator (URL) is designated, a whole Web site associated with the URL, namely, a whole target page described in a HyperText Mark-up Language (HTML) is downloaded in a browser, which operates on a personal computer (PC) or a cellular phone of a user. Even when the user desires, for example, only “sports articles” of a news site, unnecessary information pieces other than the desired information of sports articles stored in the site such as news items including political articles and economic articles are also downloaded. This results in handling of an extra amount of data and causes an unnecessary download cost.

In the internet communication with a cellular widely used in recent years, the user is charged in units of packets. As above, the information items not necessary for the user are also downloaded to resultantly increase the communication cost.

JP-A-2001-229171 describes a technique to browse an Web site. According to the technique described in the specification of the article, a plurality of sites of stores respectively describe meta-tags in home pages thereof, each meta-tag taking a shared or common format including a plurality of information items. As a result, each home page contains information items regarding stores and items and information retrieved by a search engine is stored in a database.

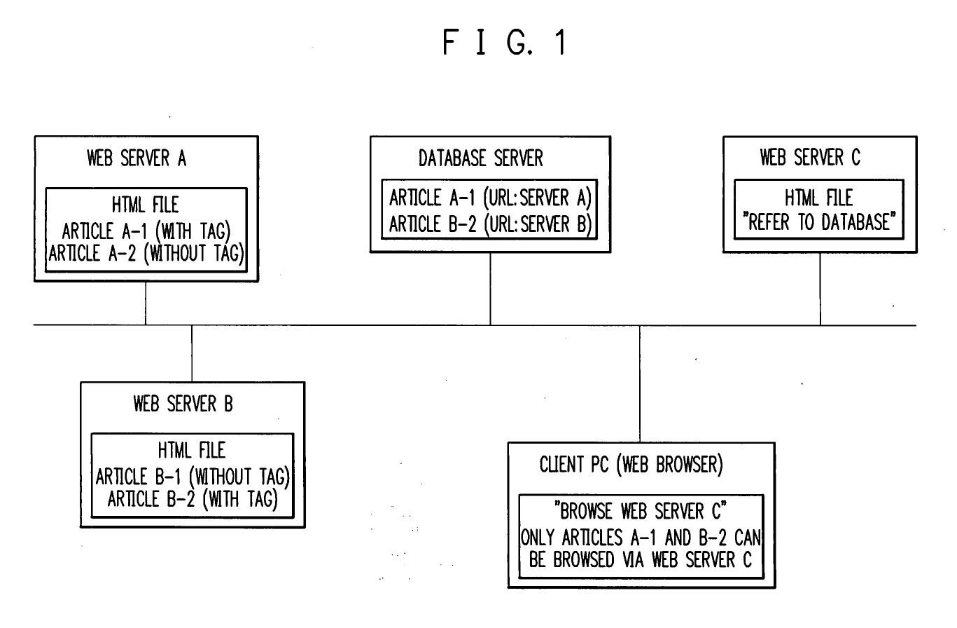

JP-A-2001-312545 describes a technique regarding a system and a method of constructing a database of information items of real estates, and a method of providing information items of real estates. According to the article, particularly, the scope of claims, FIGS. 1 and 3, and paragraph 0048, a common tag data item defining an attribute of a real estate is distributed to a plurality of Web sites such that an information item of a real estate accessed by a user is browsed on an information server.

JP-A-2003-108425 describes a technique also associated with an information processing system. According to the article, a URL information item and a keyword are written together with a tag which links the URL information item with the keyword in a record field of the keyword such that an HTML file linked as above is transmitted to a user terminal.

### SUMMARY OF THE INVENTION

It is therefore an object of the present invention, which has been devised in consideration of the problems, to provide a system and a method in which a Web server is linked with a database so that the service user accesses the Web server to browse at a time entire information items inherently or originally provided at a plurality of sites. This reduces the time needed for accessing the plural sites and prevents reception of data items not required for the user to thereby suppress unnecessary traffic of data.

In accordance with the present invention, there is provided an information browsing method of browsing a plurality of information items, comprising the steps of adding tags to each subject or topic in articles on Web sites, storing in a database data of the tags and the articles linked together, and then establishing communication between a single Web server and the database to enable view of the articles, which are provided from Web sites, by an access to the Web server.

In accordance with the present invention, there is provided an information browsing method for browsing a plurality of information items at a plurality of sites, wherein by accessing only one Web server, a plurality of HTML files from a plurality of Web servers can be viewed on one Web page.

In accordance with the present invention, there is provided an information browsing system for browsing a plurality of information items at a plurality of sites, wherein by accessing only one Web server, a plurality of HTML files from a plurality of Web servers can be viewed on one Web page.

In accordance with the present invention, there is provided an information browsing system for browsing a plurality of information items at a plurality of sites. The system comprises a plurality of Web servers including information of article, a database server for linking a tag, which is assigned to each particular article content or each topic of articles in the Web servers, with a particular article content to create a data item, and storing therein the data item, and a browse server capable of browsing article contents linked from the database server.

In the information browsing system, when one of the Web servers including the information of article contents is accessed and a particular article or topic is designated, other related article information in the Web servers may be retrieved, the related article information being indicated by the tag information.

In the information browsing system, the browse server may save in the database server the article contents, which is beforehand given by analyzing the article.

As above, in accordance with the present invention, a Web server is linked with a database and users can browse various information items originally provided at multiple sites at a single access to the Web server. This reduces time to access the plural sites and prevents handling of unnecessary data items. That is, the entire data obtained by the user in the prior art includes information items other than particular articles desired by the user. The present invention prevents occurrence of unnecessary traffic of data.

In the related art, a URL (i.e., a character string which is related to an HTML file with a one-to-one correspondence and indicates a storage destination of the HTML file) indicates locations of a file containing information items of various fields. This makes it possible to display all of the contents of the file. However, the URL cannot indicate just a part of the contents of the file.

In accordance with the present invention, a particular tag is related to a unit of information written in a file with a one-to-one correspondence established therebetween. By referring to information of tags or by referring to a database, any information unit can be selectively browsed.

### BRIEF DESCRIPTION OF THE DRAWING

The objects and features of the present invention will become more apparent from the consideration of the following detailed description taken in conjunction with the accompanying drawing in which FIG. 1 is a schematic block diagram showing a configuration example of a browsing system to carry out a method of browsing a plurality of information items by storing tag information in an Web page in accordance with the present invention.

### DESCRIPTION OF THE EMBODIMENTS

In the present invention, for each article in a Web site, i.e., an HTML file under consideration, a particular tag is inserted.

Each tag is beforehand described in a format, for example, as <AAANews.com Sports 20040420-002>, which means that the tag indicates “the second article in the sports column of AAA news web site on Apr. 20th, 2004 edition”. That is, the tag description corresponds to the contents of article in the site with a one-to-one correspondence. Specifically, “AAANews.com” indicates an Web site of AAA news, “Sports” means a sports column, and “20040420-002” designates the second article of the Apr. 20th, 2004 edition.

To individual information piece at each Web site, a tag is assigned in a particular format like above.

After a database server is installed, data items in which tag information is linked with URL information are stored in the database server.

There is installed a Web server to be accessed by users and HTML files to refer to the database server are stored therein.

The service user accesses the Web server disposed for user access.

By accessing the Web server installed at one location, the user can browse information items in which an associated tag is embedded, though the information items are originally provided at a plurality of sites.

[Configuration of Embodiment]

Referring next to FIG. 1, description will be given in detail of a configuration example of a first embodiment embodying a browsing method and a program to browse a plurality of information items by storing tag information in an Web page in accordance with the present invention.

As can be seen from FIG. 1, the embodiment includes Web servers to keep Web sites or HTML files such as Web server A and Web server B, a database to keep tag information assigned to the HTML files, and an Web server C to supply the data in a lump kept in the database server in the HTML file format.

The user desiring to use services accesses the Web server by use of a client personal computer and Web browser software running on the personal computer.

[Operation Example of Embodiment]

A system configuration in this embodiment is shown in FIG. 1.

The system includes a group of servers such as Web server A and Web server B to keep various Web site information items, a database server to hold a list of unique tags, and Web server C to be accessed by the service user.

Each of the servers to assign a tag to each information item in the HTML files at various Web sites beforehand adds a tag to each article in the server. The tag is unique to the article, for example, as below. The user classifies the articles according to categories and genres using, for example, a dictionary function. In addition, the user creates a table including an entry for each article. The entry includes an input day and time of the article or time of occurrence of an event associated with the contents of the article, and a frequency of appearance of the article. For an article having a larger value of the frequency of appearance, the user increases a degree of linkage to remove duplicative contents of articles and/or to delete duplicative linkage destinations. This suppresses increase in the amount of information to thereby control the information amount.

In the embodiment, a database server is installed to keep therein data items regarding tags contained in the respective HTML files at Web sites.

Web servers are arranged on a network to display or to create HTML files to refer to the database.

When a client personal computer, i.e., a terminal of a service user accesses an Web server, there can be displayed on a Web browser various articles in a lump which are contained in the HTML files kept at mutually different Web sites and which are recorded in the database server, i.e., which are assigned with respective tags.

For example, the database server holds a list of unique tags.

Each unique tag keeps therein information of a link to a location of a target article or a copy of information of the target article. For example, the link information for a news article in an HTML file is described as “www.xox. Co.jp/index.html”. This indicates that the news article is in a second position in the category of the article. However, in accordance with the present invention, the link information or the copy of the information of the target article can be replaced by a known method.

The Web server such as Web server C that is accessed by the user keeps therein Web sites (HTML files) which are linked with a list of unique tags held in the database server.

Substantially, when the user accesses Web server C, the user can automatically select information of articles held by Web servers A and B, which are included in the list held in the database server, without accessing other servers. The present invention provides a user-friendly retrieval space without conventionally required time and operations to select site information.

That is, the client needs only to access Web server C. The operation to retrieve linkage destinations using a search engine and/or a dictionary function can be dispensed with. The client exploits commonality of genres, dates and hours, and image information and substantially retrieves similar information. Further, a learning system may be employed. Furthermore, the client may exploit appropriate combinations of at least two kinds of extraction such as keyword extraction and extraction by similar/same image information to thereby reflect a result in the classification of Web server C. Web server C can reflect a desire of the client to dispose additional classification items to thereby provide a service to meet the requests of the user.

It is also possible that degrees of importance assigned to particular articles are expressed in numeric values to arrange information items of the articles in Web server C according to the values. Also, it is possible that degrees of interest of users are expressed in numeric values according to time of article's occurrence or inputs. The numeric values are classified into many levels to accordingly determine the number of links to associated articles to thereby keep the number of links in Web server C.

In addition, there can be disposed particular articles and/or a topics column such that a table of the particular articles and/or topics column is disposed in Web server C and tags are inserted in the table.

In the embodiment, for example, Web server C accesses the database server to assign tags to associated article information items in Web server A, Web server B, . . . on the Internet. In the database server, information items of articles in the same predetermined language are collected in a set. The information items of articles are classified according to genres such as a sports article, an accident article and so on. The information items of each set are further classified according to, for example, “date and hour”, “location or region”, or “keyword”, and the classified information items are stored in the database server. Basically, for each article of each Web server, an address of each information item in a region classified as above is related to a link destination information item. For example, in the database server shown in FIG. 1, articles A-1 of a particular genre and B-2 of a particular genre are equal in the genre. The contents thereof are same or similar to each other and hence are saved in a predetermined save area as an associated link destination.

For equality or similarity of the contents of articles, for example, the article contents may include common keywords such as nouns and a threshold value S may be set for the number of common keywords. There may be defined a degree of commonness A, i.e., the number of common keywords, the amount of the article B and a density D of the degree of commonness according to the amount of the article (=degree of commonness A÷amount of contents of article B). The number of links can be determined using the threshold value S, the degree of commonness A, and the density of degree of commonness D. It is also possible to think the number of types of common keywords C, define a parameter expression of A, B, C and D and create a correlation table. For each article, strength of a link of its contents is determined according to the expression.

According to the method, Web server C can associate articles to each other and store the articles in one save area. This enables the operation to provide a service in response to an access from a client. That is, the client needs only to access an Web site to automatically retrieve related information items without designating the contents of related articles.

In accordance with the present invention, by registering desired news categories in advance, necessary information items from a plurality of Web sites can be browsed on a single Web page. This makes it possible to retrieve information in a shorter period of time. For a packet charging service, since only the necessary information can be downloaded, the communication cost is reduced.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. An information browsing method for browsing a plurality of information items, comprising the steps of:
adding tags to each subject or topic in articles on Web sites;
storing in a database data of the tags and the articles linked together;
establishing communication between a single Web server and the database to enable view of the articles, which are provided from Web sites, by an access to the Web server.

2. An information browsing method for browsing a plurality of information items at a plurality of sites, wherein by accessing only one Web server, a plurality of HTML files from a plurality of Web servers can be viewed on one Web page.

3. An information browsing system for browsing a plurality of information items at a plurality of sites, wherein by accessing only one Web server, a plurality of HTML files from a plurality of Web servers can be viewed on one Web page.

4. An information browsing system for browsing a plurality of information items at a plurality of sites, comprising:
a plurality of Web servers including information of article;
a database server for linking a tag, which is assigned to each particular article content or each topic of articles in the Web servers, with a particular article content to create a data item, and storing therein the data item; and
a browse server capable of browsing article contents linked from the database server.

5. An information browsing system in accordance with claim 4, wherein when one of the Web servers including the information of article contents is accessed and a particular article or topic is designated, other related article information in the Web servers are retrieved, the related article information being indicated by the tag information.

6. An information browsing system in accordance with claim 4, wherein the browse server saves in the database server the article contents, which is beforehand given by analyzing the article.
